(19) United States
(12) Patent Application Publication
(10) Pub. No.: US 2016/0181809 A1
(43) Pub. Date: Jun. 23, 2016

(54) GRID SYSTEM CONDUCIVE TO ENHANCEMENT OF POWER SUPPLY PERFORMANCE

(71) Applicant: NATIONAL CHUNG SHAN INSTITUTE OF SCIENCE AND TECHNOLOGY, Longtan Township (TW)

(72) Inventors: HSUANG-CHANG CHIANG, LONGTAN TOWNSHIP (TW); KUO-KUANG JEN, LONGTAN TOWNSHIP (TW); GWO-HUEI YOU, LONGTAN TOWNSHIP (TW); KE-CHIH LIU, LONGTAN TOWNSHIP (TW)

(21) Appl. No.: 14/572,869

(22) Filed: Dec. 17, 2014

(51) Int. Cl. H02J 3/38

(52) U.S. Cl. CPC H02J 3/383; H02J 2003/388

(57) ABSTRACT

A grid system conducive to enhancement of power supply performance comprises a plurality of signal regulation devices are jointly connected to a load; the signal regulation devices are each connected to a DC/DC conversion circuit and a DC/AC changing circuit through a power modulation module; an input end of the DC/DC conversion circuit receives a power signal provided by a renewable power module, and then the power modulation module performs loop control on the DC/DC conversion circuit and the DC/AC changing circuit in accordance with the power signal, the load, and/or a power state of utility electricity, such that output power of the grid system maintains high stability and low distortion and attains a satisfactory power adjustment rate at a low cost so as to make good use of all power resources and thus enhance the efficiency of overall power utilization of the grid system.

### FIELD OF TECHNOLOGY

The present invention relates to grid systems, and more particularly, to a grid system conducive to enhancement of power supply performance.

### BACKGROUND

Due to rapid industrial development and technological advancement, conventional fossil fuels not only incur high costs but also cause environmental pollution. To save energy and reduce carbon emissions, great importance is attached to green renewable energy, such as wind power and solar energy. To turn renewable energy into utility electricity, it is necessary to deliver power to an electricity utility via a storage battery. But both the power delivery process and the energy conversion process lead to the loss of a huge amount of power. A traditional way of enhancing their efficiency requires constructing a grid system from renewable energy-based power generation systems. Although the renewable energy-based power generation system technology is sophisticated nowadays, the construction of a reliable grid system hinges on plenty of related techniques.

A conventional grid system not only requires a renewable energy source and a converter thereof, but also requires an inverter adapted to store energy and parallel-connected to a public grid. When the public grid is functioning well, exchange of energy between the public grid and grid power takes place. When the public grid is malfunctioning, “decoupling” must be immediately carried out in order to preclude the islanding effect (which means that, for example, in case of a failure to strike a balance between the supply of power and the requirement of a load, the grid system will supply power to a portion of the load only), and thus an uninterruptible power supply (UPS) is required to supply power to the load of the grid system. The grid system is characterized in that: a renewable energy source and a converter thereof can get “connected in parallel” at any time; the inverters are instantly available in the public grid; hence, there must be automatic shunting, signal regulation, and absence of control signal connection between all the inverters in order to enhance industrial applicability of the grid system. In a stand-alone mode, STM (not connected to utility electricity), a usual power sharing and voltage control method is the P-ω or Q-V descent method (hereinafter referred to as the “descent method”) characterized in that, depending on a predetermined prescheduled P-Q decrease extent, each inverter can share power and adjust its own grid voltage without any control signal connection.

Taiwan utility model patent M478289, entitled Inverter Control System, is mainly intended to balance the state of charge (SOC) of each battery module in a power-storing grid, effectuate automatic output shunting, and dispense with any control signal connection. The inverter control system comprises a power parallel-connected control module and a parallel-connected shunting control module. The parallel-connected shunting control module is connected to the power parallel-connected control module. The power parallel-connected control module comprises a low-pass filter, a frequency calculating unit, a voltage calculating unit, a sine wave generator, and a phase shift circuit. The parallel-connected shunting control module comprises a battery SOC recording unit, a virtual resistance calculator, a proportional amplifier, and an inverter power switching circuit.

The power parallel-connected control module receives output current of an inverter, filters noise out of the output current of the inverter with the low-pass filter, multiplies a sine wave signal by a cosine wave signal generated from the sine wave generator and the phase shift circuit respectively so as to obtain a real power signal and a virtual power signal respectively, calculates a frequency signal and a voltage signal by the descent method, generates another sine wave signal from the frequency signal with the sine wave generator, multiplies the another sine wave signal by the voltage signal to obtain the primary output voltage signal of the inverter, and uses the power parallel-connected control module to controllably make the voltage and frequency of all the inverters equal. The parallel-connected shunting control module receives a load current and the SOC of the battery module, calculates an inverter secondary output voltage signal with the virtual resistance calculator, synthesizes the inverter primary and secondary output voltage signals to obtain a synthetic voltage signal, subtracts the existing inverter output voltage signal from the synthetic voltage signal, generates an inverter output from the proportional amplifier, sends the inverter output to the current signal of the load, adds the inverter output to the actual current signal of the load to obtain a driving signal for controlling the inverter power switching circuit, such that the multiple inverters are capable of parallel connection and balancing the shunting of the SOC of the battery module.

As indicated by the aforesaid prior art, a conventional grid system allows the exchange between its own grid power and the public grid and enables parallel connection without any communication connection by resorting to the descent method and in accordance with a P-Q decrease extent prescheduled according to its own capacity. However, the descent method is likely to cause grid voltage and frequency to vary instantly with a change in the amount of power generated from renewable energy, energy storing, and load requirement, thereby resulting in instability. In addition, switching in the STM (decoupled from utility electricity) and a parallel-connected grid mode (i.e., being parallel-connected to utility electricity) is likely to cause an overly large change in voltage and overcurrent. Taiwan utility model patent M478289 provides a technology of balancing the SOC of each battery module in a power-storing grid, effectuating automatic output shunting, and dispensing with any control signal connection. Taiwan utility model patent M478289 discloses calculating frequency signals and voltage signals by the descent method, incurs high manufacturing costs, requires the power to be parallel-connected to the control module in order to control voltages and frequencies of all the inverters and render the voltages and frequencies equal, discloses using the parallel-connected shunting control module to balance the shunting of the SOC of the battery module so as to achieve frequency stability, balance grid voltage, and balance the SOC of the battery module. Furthermore, with renewable energy-based power generation being susceptible to changes in the climate and surroundings and thus being unable to persist steadily, both the prior art and Taiwan utility model patent M478289 must operate in conjunction with a power-storing apparatus, such as a battery module. However, if the renewable energy no longer works, Taiwan utility model patent M478289 cannot provide any mechanisms for protecting the grid system and operating the grid system. Therefore, from the perspective of the prior art, it is necessary to provide a better solution.

### SUMMARY

In view of the aforesaid drawbacks of the prior art, it is an objective of the present invention to provide a grid system conducive to enhancement of power supply performance. The grid system is characterized in that: multiple renewable powers are connected to utility electricity and loads through the grid system, respectively; real-time mechanisms for parallel connection and decoupling are provided and loop control is carried out in accordance with a power state; hence, the output power of the grid system maintains high stability and low distortion so as to make good use of all power resources at a low cost and thus enhance the efficiency of overall power utilization of the grid system.

In order to achieve the above and other objectives, the present invention provides a grid system conducive to enhancement of power supply performance, comprising a plurality of signal regulation devices, a power modulation module, and an output circuit. The signal regulation devices each comprise a DC/DC conversion circuit, a DC/AC changing circuit, and a power modulation module. The DC/DC conversion circuit has a power signal input end and a transformation signal output end. The power signal input end is electrically connected to a renewable power module. The DC/AC changing circuit has a transformation signal input end and a transformation signal output end. The transformation signal input end is electrically connected to the power signal output end of the DC/DC conversion circuit. The power modulation module is electrically connected to the DC/DC conversion circuit and the DC/AC changing circuit and performs loop control on the DC/DC conversion circuit and the DC/AC changing circuit in accordance with the received plurality of signals and power states. The output circuit comprises a switch unit connected to the transformation signal output end of the DC/AC changing circuit and the power modulation module and connected to a load end and/or utility electricity. The power modulation module performs shunting control and output voltage adjustment on the DC/DC conversion circuit, the DC/AC changing circuit, and the switch unit of the output circuit in accordance with the plurality of signals, the load, and/or a power state of utility electricity and through calculation of a maximum power point.

The present invention is characterized in that: the signal regulation devices are connected to the renewable power module through a DC/DC conversion circuit to receive power from the renewable power end and are jointly connected to the output circuit through the DC/AC changing circuit; and the converted power is delivered to the load and/or utility electricity through the switch unit of the output circuit. In practice, the power modulation module calculates the maximum power point in real time in accordance with the plurality of signals, the load, and/or the power state of utility electricity to thereby perform shunting control and output voltage adjustment on the DC/DC conversion circuit, the DC/AC changing circuit, and the switch unit of the output circuit so as to adapt to the parallel connection state and decoupling state of the grid system in real time, such that the output power of the grid system maintains high stability and low distortion and attains a satisfactory power adjustment rate at a low cost so as to make good use of all power resources and thus enhance the efficiency of overall power utilization of the grid system.

### BRIEF DESCRIPTION

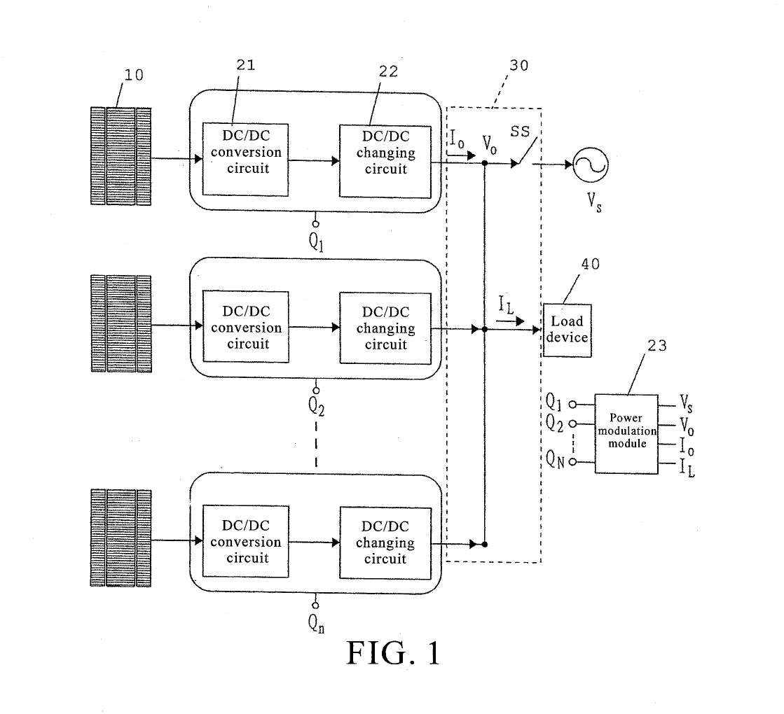

FIG. 1 is a schematic view of the framework of a system according to an embodiment of the present invention;

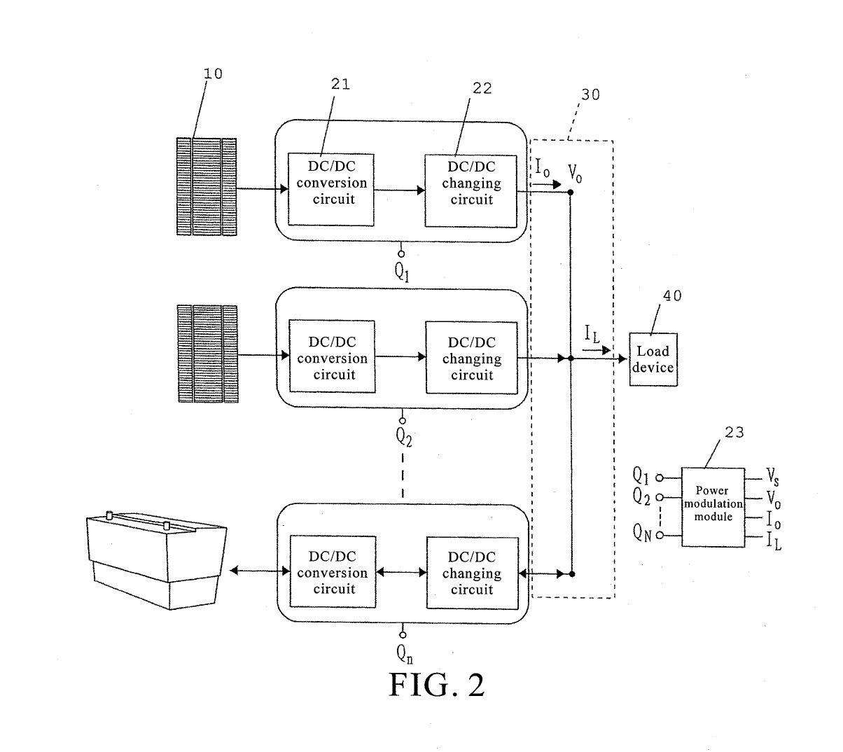

FIG. 2 is a schematic view of the framework of another system according to another embodiment of the present invention;

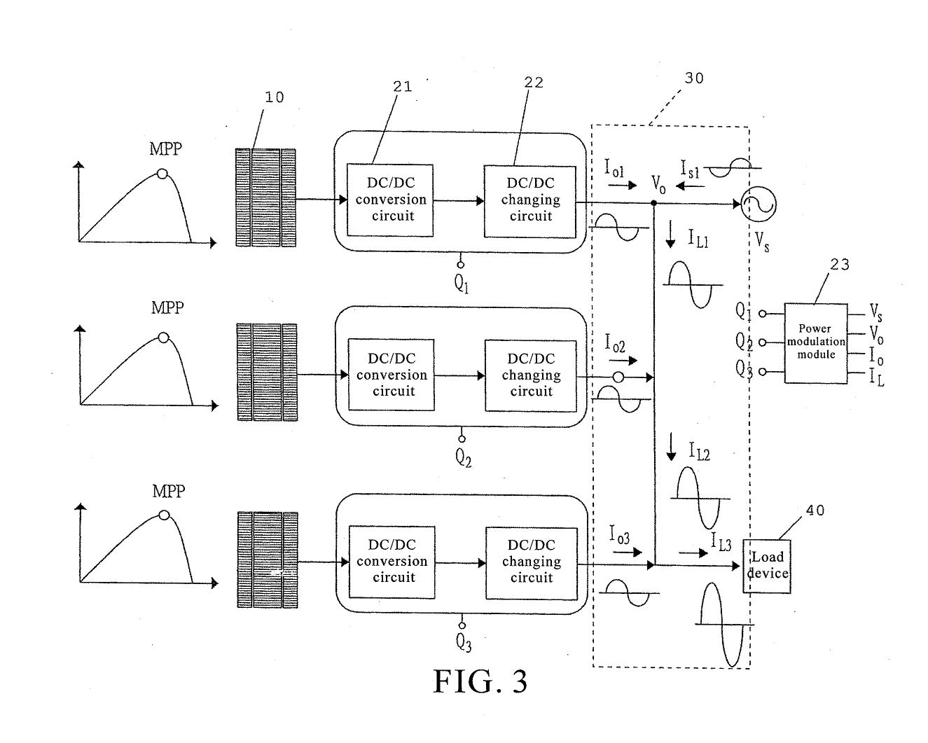

FIG. 3 is a schematic view of operation according to an embodiment of the present invention;

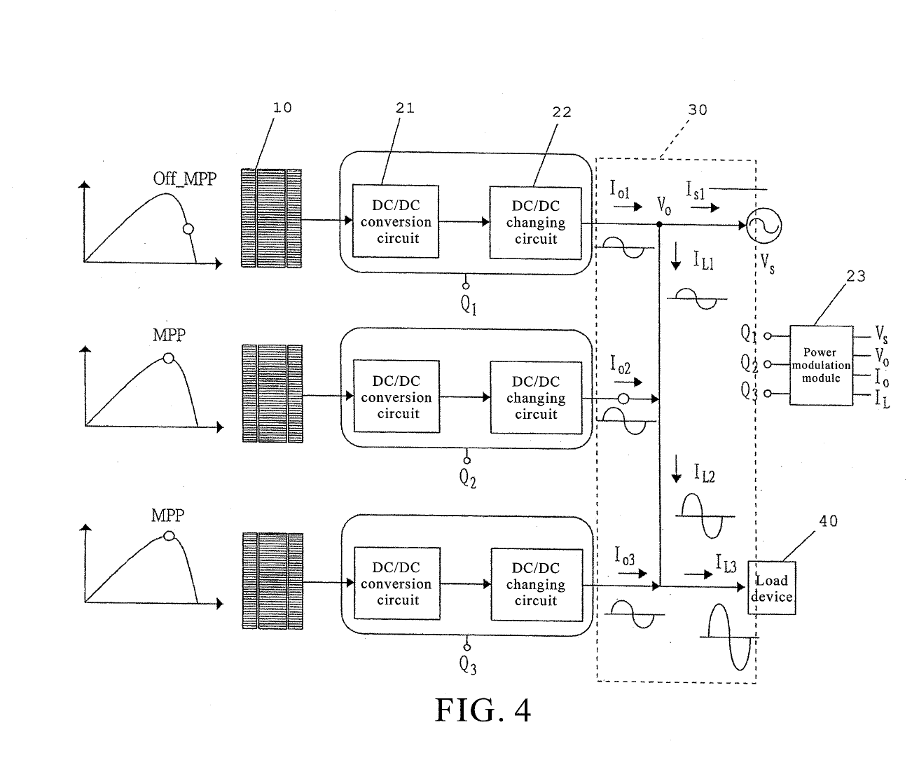

FIG. 4 is a schematic view of operation according to another embodiment of the present invention;

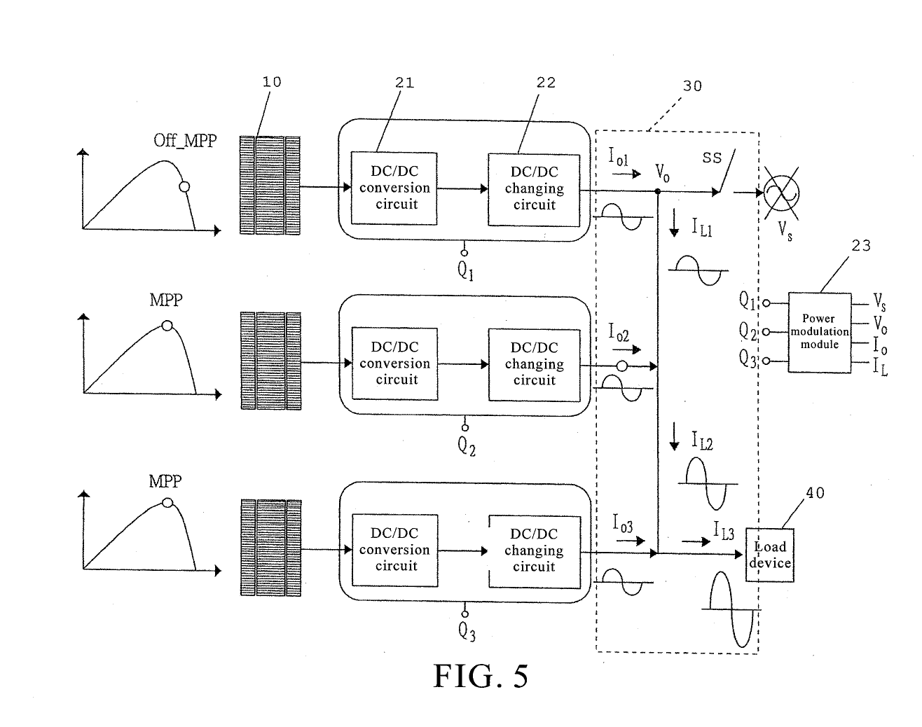

FIG. 5 is a schematic view of operation according to yet another embodiment of the present invention; and

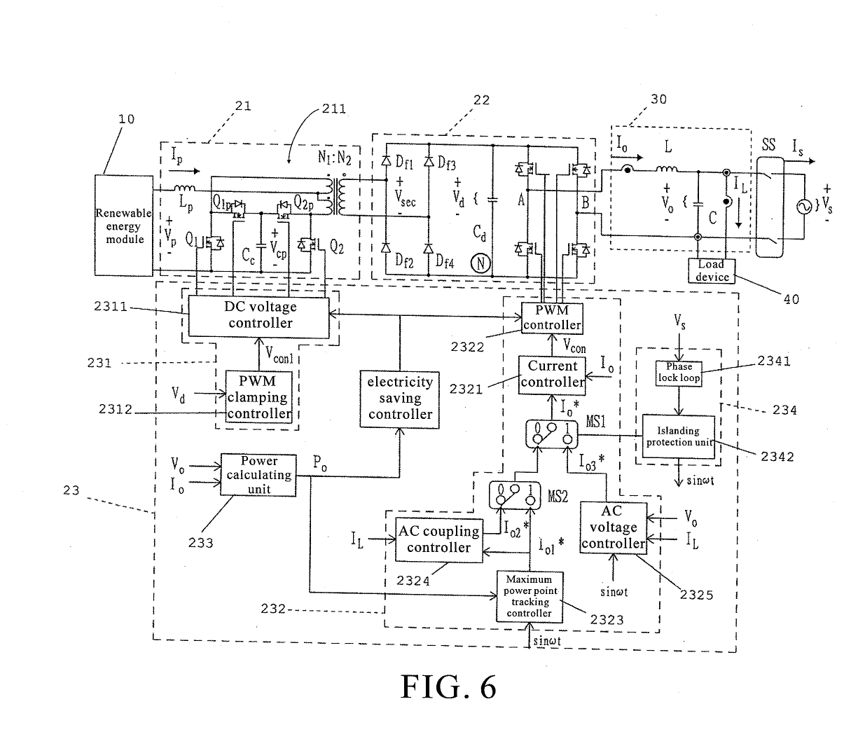

FIG. 6 is a specific applicable circuit diagram according to an embodiment of the present invention.

### DETAILED DESCRIPTION

Referring to FIG. 1 and FIG. 2, a grid system conducive to enhancement of power supply performance according to a preferred embodiment of the present invention comprises a plurality of renewable energy modules 10, a plurality of signal regulation devices, a power modulation module 23, and an output circuit 30. The renewable energy modules 10 are electrically connected to the signal regulation devices, respectively. The signal regulation devices are collectively connected to a load device 40 and/or a utility electricity power Vₛ through the output circuit 30. In this embodiment, the renewable energy modules 10 are each a renewable energy-based power generating apparatus, such as a solar module (PV module), a storage battery, or an electric generator.

The signal regulation devices each comprise a DC/DC conversion circuit 21 and a DC/AC changing circuit 22. The DC/DC conversion circuit 21 has a power signal input end and a power signal output end. The power signal input end of the DC/DC conversion circuit 21 is electrically connected to one of the renewable power modules 10. The DC/AC changing circuit 22 has a transformation signal input end and a transformation signal output end. The transformation signal input end of the DC/AC changing circuit 22 is electrically connected to the power signal output end of the DC/DC conversion circuit 21. The DC/AC changing circuit 22 sends at least an output voltage signal Vₒ and at least an output current signal Iₒ to the output circuit 30. The power modulation module 23 is electrically connected to the DC/DC conversion circuit 21 and the DC/AC changing circuit 22, receives utility electricity power Vₛ, output voltage signal Vₒ, and output current signal Iₒ, and performs loop control on the DC/DC conversion circuit 21 and the DC/AC changing circuit 22 in accordance with the received utility electricity power Vₛ, output voltage signal Vₒ, and output current signal Iₒ, respectively.

The output circuit 30 has a switch unit SS. A common end of the switch unit SS is connected to the transformation signal output end of the DC/AC changing circuit 22. A control end of the switch unit SS is connected to the power modulation module 23 of the signal regulation device and electrically connected to the load device 40 and/or utility electricity power Vₛ through a routinely-closed end of the switch unit SS. The output circuit 30 provides at least a load current signal I_{L} to the load device 40. The power modulation module 23 performs shunting control and output voltage adjustment on the DC/DC conversion circuit 21, the DC/AC changing circuit 22, and the switch unit SS of the output circuit 30 in accordance with real-time power states, such as utility electricity power Vₛ, output voltage signal Vₒ, current signal Iₒ, and load current signal I_{L}, and by calculating maximum power point tracking (MPPT) control.

The grid system of the present invention provides multiple operation options and is applicable to operation modes, such as a grid-connected mode (GCM), a line-interactive mode (LIM), and a stand-alone mode (STM). In the GCM, the signal regulation devices perform maximum power point tracking control over the renewable energy modules 10 and feed the power generated from the renewable energy modules 10 to utility electricity power Vₛ, so as to not only achieve a parallel-connected grid by means of unit power factor but also introduce virtual work into the grid system in accordance with the frequency offset of the grid system. In the LIM, although the signal regulation devices are parallel-connected to utility electricity power Vₛ, the signal regulation devices merely share load power but do not feed the power to utility electricity power Vₛ, thereby accessing only utility electricity power Vₛ and the power attributed to the renewable energy modules 10 and estimated at less than the power level of the load device 40. When the applicable scenario has a failure of utility electricity power Vₛ or has no access to utility electricity power Vₛ, the signal regulation devices operate in the STM to thereby maintain the power of the load device 40, and the renewable energy modules 10 provide the power required for all the load devices 40, wherein the parallel-connected grid system interrupts as soon as the power provided by the renewable energy modules 10 is less than the requirement of the load device 40.

For example, referring to FIG. 1, where the aforesaid operation modes apply to a mixed grid system, the grid system functions as a pure utility electricity parallel connection system when utility electricity power Vₛ is normal; when utility electricity power Vₛ fails, the switch unit SS of the output circuit 30 changes from being routinely off to being routinely on, and the operation mode changes to the STM. One of the signal regulation devices changes to the STM in order to maintain the voltage of the load device 40, whereas the other signal regulation devices operate in the LIM. If the present invention applies to a grid system which has no access to utility electricity but is operating in a bidirectional off-line manner as shown in FIG. 2, the grid system uses a combination of bidirectional primary signal regulation devices and the other signal regulation devices to form a virtual grid by adjusting the voltage of the load device 40; in this example, one of the renewable energy modules 10 is a storage battery capable of charging and discharging, whereas the other renewable energy modules 10 are solar modules, and thus all the other signal regulation devices operate in the GCM to not only supply power to the load device 40 but also use the surplus power to charge the storage battery through the primary signal regulation devices, such that the storage battery discharges to supplement the power level of the load device 40 whenever the solar module generates less power than is required to meet the power requirement of the load device 40.

FIG. 3 illustrates how the power modulation module 23 of the present invention performs shunting control and output voltage adjustment on the DC/DC conversion circuit 21, the DC/AC changing circuit 22, and the switch unit SS through the calculation of a maximum power point tracking control. Referring to FIG. 3, which shows three renewable energy modules 10 and three signal regulation devices, though their quantity disclosed herein is not restrictive of the present invention. As shown in FIG. 3, the three renewable energy modules 10 and three signal regulation devices are series-connected between utility electricity power Vₛ and the load device 40. The first signal regulation device connects with utility electricity power Vₛ and uses its signal output end to connect with the signal output end of the second signal regulation device. Likewise, the signal output end of the second signal regulation device connects with the next signal output end. By analogy, the third signal output end connects with the load device 40 eventually. The aforesaid series connection is advantageously characterized in that the third signal regulation devices, which is the closest to the load device 40 when compared with the other signal regulation devices, senses the whole of load current I_{L3}, though the third signal regulation device can only send current signal Iₒ₃ according to a corresponding one of the renewable energy modules 10. The second signal regulation device senses load current I_{L2} (=I_{L3}−Iₒ₃) and can only send current signal Iₒ₂ according to a corresponding one of the renewable energy modules 10. The first signal regulation device senses load current I_{L1}(=I_{L2}−Iₒ₂) and can only send current signal Lₒ₁ according to a corresponding one of the renewable energy modules 10. Hence, the utility electricity current taken by utility electricity power Vₛ is expressed by Iₛ₁(=I_{L1}−Iₒ₁)).

A heavy load operating in the LIM and under parallel connection control is illustrated with FIG. 3. As shown in FIG. 3, where the total amount of power generated from the three renewable energy modules 10 falls short of the power requirement of the load device 40, and all the load currents I_{L} sensed by the three signal regulation devices exceed the power supplied by the renewable energy modules 10, respectively, and thus all the three renewable energy modules 10 operate at their respective maximum power points (MPP), and in consequence the power supplied by the three signal regulation devices falls short of the power requirement of the load device 40, wherein the deficit is covered by utility electricity power Vₛ. A light load is illustrated with FIG. 4. As shown in FIG. 4, where the total power generated from the three renewable energy modules 10 exceeds the power requirement of the load device 40, but the total amount of power generated from the second and third renewable energy modules 10 falls short of the power requirement of the load device 40, wherein load currents I_{L} sensed by the second and third signal regulation devices are adequate to justify the power supplied by the corresponding ones of the renewable energy modules 10, and in consequence the second and third renewable energy modules 10 operate at their respective maximum power points (MPP), whereas the first renewable energy module 10 is restrained by the load power sensed by a corresponding one of the signal regulation devices and thus only outputs a current corresponding in strength to the load power it senses, such that a real work current fed to utility electricity power Vₛ equals zero, and in consequence the first renewable energy module 10 operates outside its maximum power point (Off_MPP).

Referring to FIG. 5, a load which is subjected to parallel connection control in the STM is depicted and described below. The first, second, and third signal regulation devices operate in the LIM. If utility electricity power Vₛ interrupts, the first signal regulation device will separate from utility electricity power Vₛ through the switch unit SS, and only the first signal regulation device will operate in the STM in order to control the voltage at a signal output end of the load device 40. Hence, like the LIM application and the shunting control, it is also feasible that the aforesaid operation is performed according to different amounts of load and different amounts of power generated from the renewable energy modules 10. But the difference between the STM in the embodiment illustrate with FIG. 5 and the LIM is that in the STM the total amount of power generated from the three renewable energy modules 10 must be sufficient to meet the power requirement of the load device 40, otherwise the first signal regulation device will be subjected to a current constraint and thus will fail to maintain the voltage required for its signal output end to connect with the load device 40. Referring to FIG. 5, where the total amount of power generated from the three renewable energy modules 10 exceeds the power requirement of the load device 40, but the total amount of power generated from the second and third renewable energy modules 10 falls short of the power requirement of the load device 40, wherein load currents I_{L} sensed by the second and third signal regulation devices are adequate to justify the power supplied by the corresponding ones of the renewable energy modules 10, and in consequence the second and third renewable energy modules 10 operate at their respective maximum power points (MPP), whereas the first signal regulation device is restrained by the load power it senses and thus only outputs a current corresponding in strength to the load power it senses so as to maintain the load voltage, and in consequence the first renewable energy module 10 operates outside its maximum power point (Off_MPP).

To further describe how the present invention applies to a specific circuit of a grid system, FIG. 6 shows that the power modulation module 23 has a first control circuit 231, a second control circuit 232, a power calculating unit 233, and a synchronous signal generating circuit 234. In this embodiment, the grid system has a two-tier circuit framework, wherein the DC/DC conversion circuit 21 is a voltage clamping current source push-pull DC/DC converter. The DC/DC conversion circuit 21 essentially comprises a transformer 211, two main switches Q₁, Q₂, and two clamping switches Q₁ₚ, Q₂ₚ. The transformer 211 has a primary side and a secondary side. The primary side has a routinely-connected winding and a switching winding. The routinely-connected winding and the switching winding are switched and thus connected in series. The secondary side has a secondary side winding connected to the transformation signal input end of the DC/AC changing circuit 22. The DC/AC changing circuit 22 is a full-bridge DC/AC inverter. The DC/AC changing circuit 22 essentially comprises four rectifying diodes D_{f1}˜D_{f4} and four power transistors functioning as switches. The transformation signal input end is formed between the four rectifying diodes D_{f1}˜D_{f4}. Transformation signal output ends A, B are formed between the four power transistors, such that the transformation signal output ends A, B of the DC/AC changing circuit 22 are electrically connected to the output circuit 30. The output circuit 30 receives real-time power states, such as output voltage signal Vₒ, output current signal Iₒ, utility electricity power Vₛ, and load current signal I_{L}.

In this embodiment, the DC/DC conversion circuit 21 maintains DC-link voltage V_{d} and exercises single loop control, such that the first control circuit 231 receives its fed-back DC-link voltage V_{d} to thereby control the DC/DC conversion circuit 21, wherein the first control circuit 231 has a DC voltage controller 2311 and a PWM clamping controller 2312. After the DC voltage controller 2311 has sent output signal V_{con1} to the PWM clamping controller 2312, the PWM clamping controller 2312 controls the main switches Q₁, Q₂ and the clamping switches Q₁ₚ, Q₂ₚ, respectively.

The second control circuit 232 comprises a current controller 2321, a PWM controller 2322, a first switching switch MS1, a second switching switch MS2, a maximum power point tracking controller 2323, an AC coupling controller 2324, and an AC voltage controller 2325. In this embodiment, the control exercised over the full-bridge DC/AC inverter comes in the form of multiple loop control, wherein the innermost loop is an inductive current loop, and the external loop generates a current command Iₒ* for comparison with the fed-back inductive current Iₒ. The current controller 2321 adjusts and sends output signal V_{con2} to the PWM controller 2322, such that the PWM controller 2322 controls the four power transistors of the DC/AC changing circuit 22. The current command Iₒ* is generated according to the aforesaid operation modes and the controlling external loop and is switched by the first and second switching switches MS1, MS2.

In this embodiment, the common end of the first switching switch MS1 connects with the current controller 2321, whereas first end 0 and second end 1 of the first switching switch MS1 connect with the common end of the second switching switch MS2, wherein the AC voltage controller 2325 as well as first end 0 and second end 1 of the second switching switch MS2 connect with the AC coupling controller 2324 and the maximum power point tracking controller 2323, respectively. The principle of the aforesaid operation modes is as follows: in the GCM, current command Iₒ₁* of the first switching switch MS1 is provided by the second switching switch MS2, whereas second switching switch MS2 is switched to the maximum power point tracking controller 2323, using output power Pₒ calculated with the power calculating unit 233 according to output voltage signal Vₒ and output current signal Iₒ of the DC/AC changing circuit 22, such that the maximum power points of the renewable energy modules 10 which are calculated with a turbulence observation technique are adjusted with output power Pₒ and then adjusted with the maximum power point tracking controller 2323 to obtain current command Iₒ₁*.

In the LIM, current command Iₒ₂* of the first switching switch MS1 is also provided by second switching switch MS2, wherein second switching switch MS2 is switched to the AC coupling controller 2324, and the least value of which is acquired as a result when the power calculated with the maximum power point tracking controller 2323 and load current signal I_{L} are compared, so as to generate current command Iₒ₂*, such that the output real power of the DC/AC changing circuit 22 is not fed back to utility electricity power Vₛ. In this embodiment, a synchronous signal sinωt required for utility electricity parallel connection and the LIM is provided by the synchronous signal generating circuit 234. The synchronous signal generating circuit 234 essentially comprises a phase lock loop (PLL) 2341 and an islanding protection unit 2342 connected to the phase lock loop (PLL) 2341. When utility electricity power Vₛ is inputted to the phase lock loop 2341 to generate synchronous signal sinωt through the islanding protection unit 2342, the islanding protection unit 2342 gets connected to synchronous switch SS of the output circuit 30. When utility electricity power Vₛ is normal, the islanding protection unit 2342 controls synchronous switch SS of the output circuit 30. When abnormality of utility electricity power Vₛ is detected, the islanding protection unit 2342 trips synchronous switch SS of the output circuit 30, such that the STM prevails. In the STM, the first switching switch MS1 is switched to its second end to provide current command Iₒ₃*. The current command Iₒ₃* of the first switching switch MS1 is provided by the AC voltage controller 2325. The AC voltage controller 2325 feeds back output voltage signal Vₒ and load current signal I_{L} in order to regulate the output voltage of the grid system, such that the output voltage of the grid system maintains low distortion and has a satisfactory voltage adjustment rate so as to make good use of all power resources and thus enhance the efficiency of overall power utilization of the grid system.

What is claimed is:

1. A grid system conducive to enhancement of power supply performance, comprising:
a plurality of signal regulation devices each comprising:
a DC/DC conversion circuit having a power signal input end and a power signal output end, wherein the power signal input end is electrically connected to a renewable power module; and
a DC/AC changing circuit having a transformation signal input end and a transformation signal output end, wherein the transformation signal input end is electrically connected to the power signal output end of the DC/DC conversion circuit;
a power modulation module electrically connected to the DC/DC conversion circuit and the DC/AC changing circuit and adapted to perform loop control on the DC/DC conversion circuit and the DC/AC changing circuit in accordance with a plurality of signal and power states received; and
an output circuit, comprising:
a switch unit connected to the power modulation module and the transformation signal output end of the DC/AC changing circuit and connected to a load end and/or utility electricity,
wherein the power modulation module performs shunting control and output voltage adjustment on the DC/DC conversion circuit, the DC/AC changing circuit, and the switch unit of the output circuit in accordance with the plurality of signals, the load, and/or a power state of utility electricity and through calculation of a maximum power point.

2. The grid system of claim 1, wherein the DC/DC conversion circuit comprises a transformer, two main switches, and two clamping switches, wherein the transformer has a primary side and a secondary side, the primary side having a routinely-connected winding and a switching winding, and the secondary side having a secondary side winding and connecting with the transformation signal input end of the DC/AC changing circuit.

3. The grid system of claim 2, wherein the DC/AC changing circuit comprises four rectifying diodes and four power transistors, with the transformation signal input end formed between the rectifying diodes, and the transformation signal output end formed between the power transistors, such that the transformation signal output end of the DC/AC changing circuit is connected to the output circuit.

4. The grid system of claim 3, wherein the power modulation module has a first control circuit, a second control circuit, a power calculating unit, and a synchronous signal generating circuit, wherein the first control circuit receives and feeds back a DC voltage for controlling the DC/DC conversion circuit, and the second control circuit controls the DC/AC changing circuit.

5. The grid system of claim 4, wherein the first control circuit of the power modulation module has a DC voltage controller and a PWM clamping controller, wherein the DC voltage controller sends an output signal to the PWM clamping controller so as for the PWM clamping controller to control the main switches and the clamping switches, respectively.

6. The grid system of claim 5, wherein the second control circuit of the power modulation module comprises a current controller, a PWM controller, a first switching switch, a second switching switch, a maximum power point tracking controller, an AC coupling controller, and an AC voltage controller, wherein the current controller generates and sends an output signal to the PWM controller so as for the PWM controller to control the four power transistors of the DC/AC changing circuit.

7. The grid system of claim 6, wherein a common end of the first switching switch is connected to the current controller, wherein a first end and a second end of the first switching switch are connected to a common end of the second switching switch and the AC voltage controller, respectively, wherein a first end and a second end of the second switching switch are connected to the AC coupling controller and the maximum power point tracking controller, respectively.

8. The grid system of claim 7, wherein the synchronous signal generating circuit of the power modulation module comprises a phase lock loop connected to an islanding protection unit, wherein the islanding protection unit generates a synchronous signal when utility electricity power is supplied to the phase lock loop.

9. The grid system of claim 8, wherein the islanding protection unit is connected to a synchronous switch of the output circuit, wherein the islanding protection unit trips the synchronous switch of the output circuit when the utility electricity power is abnormal.

10. The grid system of claim 1, wherein the renewable energy module is one of a solar module, a storage battery, and an electric generator.

11. The grid system of claim 2, wherein the renewable energy module is one of a solar module, a storage battery, and an electric generator.

12. The grid system of claim 3, wherein the renewable energy module is one of a solar module, a storage battery, and an electric generator.

13. The grid system of claim 4, wherein the renewable energy module is one of a solar module, a storage battery, and an electric generator.

14. The grid system of claim 5, wherein the renewable energy module is one of a solar module, a storage battery, and an electric generator.

15. The grid system of claim 6, wherein the renewable energy module is one of a solar module, a storage battery, and an electric generator.

16. The grid system of claim 7, wherein the renewable energy module is one of a solar module, a storage battery, and an electric generator.

17. The grid system of claim 8, wherein the renewable energy module is one of a solar module, a storage battery, and an electric generator.

18. The grid system of claim 9, wherein the renewable energy module is one of a solar module, a storage battery, and an electric generator.
